(19) United States
(12) Patent Application Publication
(10) Pub. No.: US 2014/0330770 A1
(43) Pub. Date: Nov. 6, 2014

(54) CONTEXT-AWARE IMPLICIT AND EXPLICIT SEARCH

(71) Applicant: GFACE GMBH, Frankfurt/Main (DE)

(72) Inventor: Cevat Yerli, Frankfurt/Main (DE)

(21) Appl. No.: 13/887,270

(22) Filed: May 3, 2013

(51) Int. Cl. G06F 17/30

(52) U.S. Cl. CPC G06F 17/30424
USPC 707/609; 707/770; 707/728; 707/732

(57) ABSTRACT

A computer-implemented method for searching data of an online service and a corresponding online system are described, wherein the method comprises receiving a search query originating from a client device operated by a user, accessing at least one data cloud provided by the online service, performing a search on a data pool maintained by the online service using the search query, including searching the data pool subject to the search query and refining results of the search based on the at least one data cloud, and sending a search response based on the refined results of the search to the client device.

### TECHNICAL FIELD

The present disclosure relates to searching data of an online service and, in particular, to a search method and an online system providing search functionality.

### BACKGROUND

The Internet or World Wide Web provides an overwhelming amount of data and information. Since data and information are only very rarely well organized and structured, it may be difficult to directly find information satisfying the information needs of the user. Searching for data and information may also be a difficult and tedious task, since results of a search may be less relevant or inappropriate. Or, viewed from another angle, it may be difficult to formulate a search query that leads to results reflecting information desired by the user. Current search facilities utilized throughout the Internet generally offer little or no control over the results aside from a formulation of the actual search query. Typically, users have no possibility of further customizing or influencing potential search results and dynamically adjusting actual results. This leads to less relevant or irrelevant information being returned, as well as unwanted or unrelated advertisements being provided on search Web sites or respective Web pages.

### SUMMARY

The present disclosure describes an adaptable search functionality, which delivers more suitable and satisfactory search results, as well as a search functionality that enables dynamic adjustment of search results.

The present disclosure describes a computer-implemented method for searching data of an online service, and an online system as defined in the independent claims. Furthermore, a computer-readable medium is defined.

A first aspect of the present disclosure provides a computer-implemented method for searching data of an online service, which comprises the steps of receiving a search query originating from a client device operated by a user, and accessing at least one data cloud provided by the online service. Each data cloud includes one or more items related to interests of the user. A search on a data pool maintained by the online service is performed using the search query, including searching the data pool subject to the search query, and refining results of the search based on the items of the at least one data cloud. A search response that is based on the refined results of the search is sent to the client device.

The method allows for searching content, wherein the search may be implicitly shaped by the online service and explicitly influenced and controlled by the user, thereby ensuring that the user receives meaningful and significant search content that is of particular relevance and interest to the user. The online service, such as a social or gaming network, may maintain a data pool including various data on content and activities provided by the online service, as well as data on users of the online service. The online service may be accessed by a plurality of users, such as via client devices that may connect to a server hosting the online service or a gateway to the online service. The users may interact with the online service according to the activities and functionality exposed by the online service. The online service may track any interaction of users, and may store corresponding information and data in the data pool and/or in respective data clouds associated with the user.

In order to perform a search, the user may formulate a search query, for example, by typing in or selecting a search string or keywords, which may be proposed or auto-completed by the online service. The search query may also be automatically generated by the online service, for example, based on current behavior of the user or the current activity performed by the user within the online service. Whenever a search query is received, the data pool may be searched for matching content subject to the search query. Either the search query may include a search string, which may be directly used as input for the search, and/or the syntax and/or semantics of the search query may be analyzed, and the results of the analysis can be used to drive the search in the data pool. Hence, the user may also formulate a sentence, and the online service may analyze the content of the sentence and automatically extract a search string used for the search.

The online service may keep a plurality of data clouds that can be personalized for at least some of the users of the online service. The items of a data cloud may be organized as nodes, such as nodes of a directed or undirected graph, including data, keywords, tags, links, and/or other connections with other nodes of the data cloud, which may indicate or characterize interests or a preferred behavior or activities of the user, for example, by identifying favorite topics or content accessed by the user, as well as functionality and activities provided by the online service frequently used by the user. Hence, a data cloud may be represented as a graph wherein the nodes correspond to the items and the edges to links or connections between the items. The online service may provide and maintain one or more data clouds for each user and may select individual data clouds and use their content to refine the results of the search in the data pool. For example, the online service may implicitly maintain a data cloud for each user that includes data indicative of current interests and activities of the user. Such an implicitly maintained data cloud may also be referred to as an interest cloud herein.

Since the data clouds represent current interests of the user, the search results may be individually refined for the particular user without requiring any further specification of the search query by the user. The interest cloud may, therefore, be directly used by the online service to implicitly refine the search results. Hence, the search is adapted to user interests and, therefore, delivers more appropriate and satisfactory search results.

In one embodiment, at least one of the data clouds further includes ratings associated with respective items of the data cloud. Accordingly, the results of the search may be refined based on the items and the ratings of the at least one data cloud. The items and connections between items may be rated, for example, by associating numerical weights, alpha-numerical values, or symbols to the connections or items.

According to another embodiment, the method further comprises receiving update information related to at least one item of the at least one data cloud, updating the at least one data cloud based on the update information, and dynamically refining the results of the search based on the updated at least one data cloud. The update information may also relate to at least one rating of the at least one data cloud. An updated or adjusted data cloud may directly lead to a refined result of the search. For example, the user may define or adjust new ratings of items in a data cloud. The respective updated items or rating may directly affect the search, since the items and/or ratings will be directly considered during refinement of the search results. Hence, the user may explicitly control an existing data cloud maintained by the online service, such as the interest cloud of the user. This is advantageous in cases where the automatically generated items and ratings of the interest cloud may be inappropriate.

According to an illustrative embodiment, the method further comprises receiving data on new items from the user, creating a further data cloud including the new items, and dynamically refining the results of the search based on the at least one data cloud and the further data cloud. Accordingly, if the content of a data cloud, such as the interest cloud, is inappropriate, or an appropriate interest cloud does not exist, the user may explicitly specify one or more further data clouds for search purposes. Such explicitly defined data clouds may also be referred to as search tag clouds or search clouds herein. In a search tag cloud, the user may explicitly identify temporal interests or adjust preferred interests and their ratings. For example, new items corresponding to searchable words or tags may be placed into the search tag cloud and may be further manually sized up or down to alter, i.e., increase or decrease the user's importance rating for that particular item, word, or topic. It is to be understood that items related to words or topics can also be deleted from a data cloud, and new words or topics can be created, modified, and adjusted in any suitable way. This, of course, may have an immediate effect on the refinement of the search results, since any new search or even the current search results may be adjusted to the actual user's interest tags and rating levels they have allocated to them at any given time in the interest cloud or in a dedicated search tag cloud. Accordingly, the user may explicitly and dynamically control any search topic with regard to context and time as defined by the items and/or ratings of the data clouds.

The online service may also utilize search tag clouds to explicitly adjust or refine search results. Accordingly, the search results may be implicitly affected by the online service through accessing an interest cloud of the user and further explicitly affected by the user, which may define a search tag cloud or adjust the items according to current interests. Explicit control of the search may, therefore, be achieved by specifying dedicated search tag clouds or adjusting interest clouds, which may be both handled by the system as data clouds in the same way or in a similar way. For example, a user may give specific rating levels to items of his or her interest cloud and may further enhance the explicit control by creating a search tag cloud. This is, in particular, advantageous in cases where appropriate interest clouds do not exist. Hence, this type of explicit user control not only allows for the dimensions of context and time to be added to any search, it also allows for fine tuning of search results.

In yet another embodiment, the method further comprises weighing the results of the search according to a relevance of each result in respect to the items and/or ratings of the at least one data cloud. The user's search results may be derived from the interest cloud or another data cloud implicitly maintained by the online service. The resulting search results may be weighted by the online service, for example, according to a high to low rating. The high to low rating may depend on the relevance of the search query in respect to the user's interest cloud and the importance ratings the user has given to the respective items or tags therein.

According to an illustrative embodiment, the method further comprises implicitly weighing the results of the search based on an interest cloud of the user maintained by the online service. The online service may utilize the user's interests encoded in a respective interest cloud to identify important interests of the user and rate them appropriately. Based on this knowledge, the online service may allocate a weighting to the search results in the data pool, where highly weighted search results may have a higher relevance for important interests, and lowly weighted search results may have a lower relevance. This has the advantage that more relevant and better-targeted search results are delivered to the user.

In yet another embodiment, the method further comprises tracking the user and dynamically creating items in the data cloud based on the tracking. Tracking may include receiving current data from sensors associated with the user, such as sensors attached to a client device of the user, for example, positional or tracking sensors, height sensors, temperature sensors, other environmental sensors, and/or pulse sensors and other physiological sensors attached to the user or arranged within smart phones or other mobile devices. However, tracking may also include information derived from current activities and actions performed by the user in the online service or elsewhere with other users of the online service, or directly with the online service, such as initiating a conversation, a chat, or an activity, such as accessing or sharing online content, starting an online game or multiplayer game, and the like. Tags associated with the tracked behavior or activity reflecting current interests of the user may be included as items in one of the data clouds, such as in the interest cloud or an explicit search cloud, and used for refining the results of the search.

According to another embodiment, the method further comprises deriving a geographical position of the user. The geographical position or location may be, for example, associated with a name of a street, city, area, country, and/or continent, and the respective name may be included as one or more possibly interconnected items within a search cloud. Hence, the search results may be dynamically adjusted to localized information.

In yet another embodiment, the method further comprises refining the results of the search based on an indication of a time or time range, which may be preferably included in the search query. The online service may, for example, filter any search results related to a particular date or time range, such as an evening or morning of a day.

In yet another embodiment, the method further comprises accessing a data store including advertisement data, selecting at least one advertisement based on the search query and the at least one data cloud, and enhancing the search response with the at least one advertisement.

According to an illustrative embodiment, the method further comprises pushing the at least one advertisement to the client device. Hence, the advertisement may also be delivered to the client device of the user independently of search results, as well as in a combination with the search results. For example, the search results may be directly merged with the advertisements, such as in a list including search results and advertisements.

According to another aspect, a computer-readable medium (e.g., a non-transitory medium such as a memory or storage medium) is provided, which has instructions stored thereon, wherein said instructions, in response to execution by a computing device, cause said computing device to automatically perform a method according to embodiments disclosed herein. The computing device hosting the online service may remotely or locally access the computer-readable medium and read the instructions in order to configure the online service to perform the search method. For example, the computer readable medium may be provided in a client device of the user utilized for accessing the online service, in a terminal device utilized for maintaining the online service, or the computing device itself, which may provide respective means for accessing the computer-readable medium and means for connecting to the online service. After reading the instructions from the computer-readable medium, the instructions may be transferred to a processing component or the computing device hosting the online service and executed.

According to an embodiment, by executing the instructions, the computing device is configured to automatically receive a search query originating from a client device operated by a user, access at least one data cloud provided by the online service, and perform a search on a data pool maintained by the online service using the search query by searching the data pool subject to the search query and refining results of the search based on the at least one data cloud. Each data cloud may include one or more items related to interests of the user, and the results of the search may be refined based on the items of the at least one data cloud. The computing device is further configured to send a search response based on the refined results of the search to the client device.

According to yet another aspect, an online system hosting an online service is provided, wherein the online system comprises an input interface configured to receive a search query originating from a client device operated by a user, a data pool storing information related to the online service, a storage configured to store at least one data cloud, each data cloud including one or more items related to interests of the user, a processing component, and an output interface. The processing component may be configured to access the storage, retrieve at least one data cloud related to the user, and perform a search on the data pool according to the search query by searching the data pool subject to the search query and refining results of the search based on the items of the at least one data cloud. In turn, the output interface is configured to send a search response based on the refined results of the search to the client device.

The online system provides an online service with adaptable search functionality providing relevant and targeted search results, which can be dynamically controlled and adjusted using data implicitly maintained by the online service, such as interest clouds defining the user's preferred interests, as well as explicitly supplied data, such as search clouds defining the user's current information needs.

According to one embodiment, the input interface is further configured to receive update information related to at least one item and/or rating of the at least one data cloud, wherein the processing component is further configured to update the at least one data cloud based on the update information and dynamically refine the results of the search based on the updated at least one data cloud.

In yet another embodiment, the input interface is further configured to receive data on new items from the user, wherein the processing component is further configured to create a further data cloud including the new items and dynamically refine the results of the search based on the updated at least one data cloud and the further data cloud.

In yet another embodiment, the processing component is further configured to weight the results of the search according to a relevance of each result in respect to the items and/or ratings of the at least one data cloud.

According to another embodiment, the storage stores an interest cloud of the user maintained by the online service, wherein the processing component is further configured to implicitly weight the results of the search based on the interest cloud.

In yet another embodiment, the system further comprises a tracking component configured to track the user and dynamically create items in at least one data cloud based on the tracked information associated with the user. The tracking component may, for example, access a tracking sensor attached to, or otherwise associated with, the client device and/or user, and may retrieve current data on behavior, activities, constitution, and/or interests of the user.

In an illustrative embodiment, at least one item of the data cloud is indicative of the geographical position or location of the user.

In yet another embodiment, the processing component is further configured to derive the geographical position utilizing a tracking sensor, such as a GPS sensor or the like.

According to yet another embodiment, the search query includes an indication of a time or a time range, wherein the processing component is further configured to refine the results of the search based on the indication of the time or the time range.

In one embodiment, the system further comprises a data store including advertisement data, wherein the processing component is further configured to access the data store, select at least one advertisement based on the search query and the at least one data cloud, and enhance the search response with the at least one advertisement. The data store may be co-located with the data pool and the storage of the system, or may be accessed and located remotely at the advertiser's site. Similarly, the system may also be configured to access a plurality of data stores associated with different advertisers.

In another embodiment, the output interface is further configured to push the at least one advertisement to the client device.

In yet another embodiment, the search response includes one or more of a text, a video clip, an image, an email, a message, and audio content. The search results may be delivered in the various formats to various platform types, such as PCs, tablets, smart phones, internet-enabled devices, and similar client devices, for example, internet-enabled TVs and game consoles.

### DESCRIPTION OF THE DRAWINGS

The specific features, aspects, and advantages of the present disclosure will be better understood with regard to the following description and accompanying drawings where:

FIG. 1 shows a flowchart of a search procedure according to one embodiment;

FIG. 2 shows a flowchart of a search procedure according to another embodiment;

FIG. 3 depicts a search tag cloud utilized in one embodiment;

FIG. 4 shows details of an interest cloud used in one embodiment; and

FIG. 5 illustrates a search query and search results as obtained by a search according to one embodiment.

### DETAILED DESCRIPTION

In the following description, reference is made to drawings that show, by way of illustration, various embodiments. Also, various embodiments will be described below by referring to several examples. It is to be understood that the embodiments may include changes in design and structure without departing from the scope of the claimed subject matter.

Online services, such as social networks, gaming environments, cloud-based services, user networks, gaming networks, online platforms, online systems, communication and networking sites, and other systems and interfaces, which may be accessible via a network by a plurality of users operating client devices or other remote terminals, enable users to share online content within the online service and to participate in activities provided by the online service. For example, each user may be connected via a client device to at least one server hosting the online service. The respective server may provide the user with one or more interfaces that may be rendered or displayed on the client device or terminal and allow the user to interact with the online service. For example, a server may generate a personalized page that may be rendered on a client device of the user. The user may apply any interaction technique available on his or her client device, such as mouse interaction, keyboard interaction, gesture recognition, or touch recognition, and the interaction input may be transferred to the server where the input may be further processed in order to trigger a certain functionality. Similarly, the input may also be processed on the client device, in order to provide the server with commands or instructions on how to further proceed.

The various activities and actions of each user with regard to content provided via the online service may be tracked by the online service, and respective personalized data may be stored. For example, the personalized data may be stored in a data cloud, such as in an interest cloud, wherein each content, action, or activity may be associated with an interest, such as by extracting one or more tags assigned to the content, action, or activity. The interest and/or the one or more tags may be included as respective items in the data cloud, linked or connected with each other or with other items, and/or weighted based on a relevance to current or preferred interests or needs of the user. For example, if a user accesses a certain content or resource provided by the online service, the online service may analyze the tags assigned to the online content or resource and include these tags in the data cloud or interest cloud associated with the user. The online service may further compare the new tags with already stored tags and may increase respective weights and/or ratings according to similarity measures.

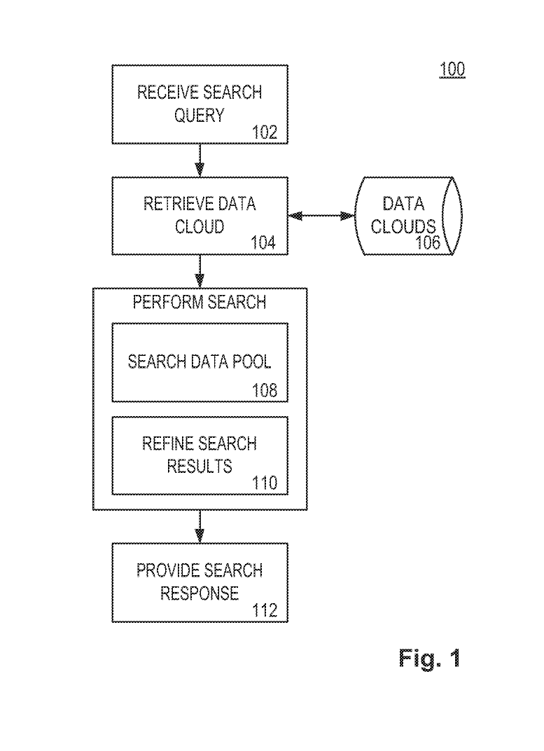

The activities and actions performed within the online service may include a search for data maintained by the online service in order to satisfy the information needs of a user. For example, a user may be interested in online content or activities provided by the online service that are related to a certain topic. Hence, the user may formulate a search query and submit the search query to the online service. As shown in FIG. 1, which illustrates a flowchart of a method 100 for searching data of an online service according to one embodiment, the online service or a respective component or module of the online service may receive the search query from a user in step 102, and may retrieve one or more data clouds of the user in step 104. The online service may store a plurality of data clouds for at least some users of the online service in one or more databases 106 or any other suitable storage or memory. Accordingly, the data clouds of the user may be retrieved by accessing the database 106. Each retrieved data cloud may include one or more items that are related to interests of the user and ratings associated with respective items. For example, a data cloud may correspond to an interest cloud of the user, which may be automatically maintained by the online service. Based on the retrieved one or more data clouds and the search query, a data pool of the online service including information related to the online service, such as data on content, resources, actions, and activities provided by the online service, may be searched in step 108, and the results of the search may be refined based on the items and ratings of the at least one data cloud in step 110. The refined results may be used to formulate a search response that may be sent back to the client device of the user in step 112.

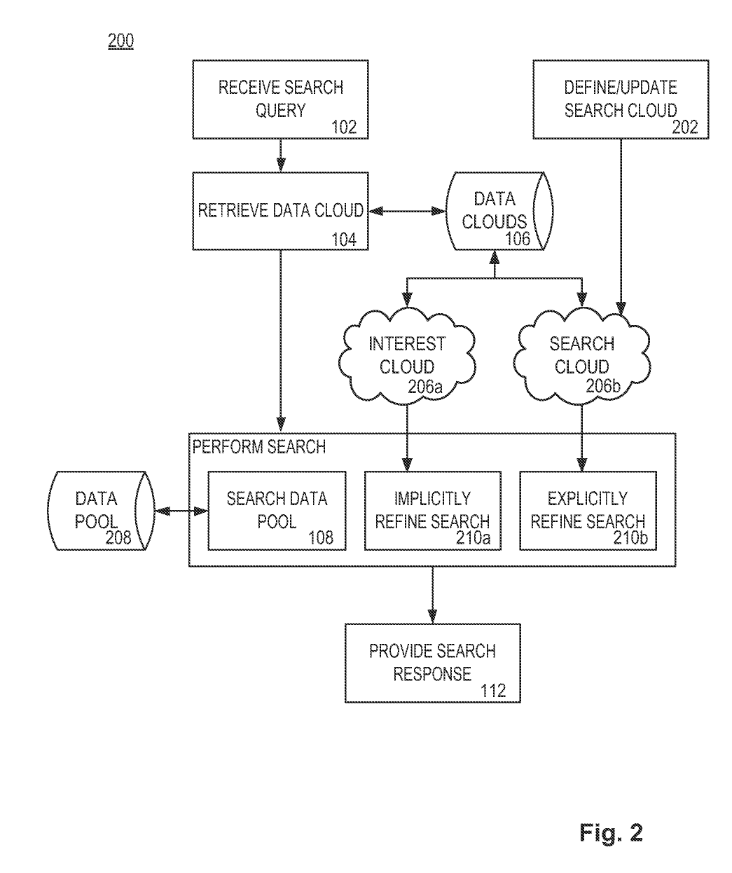

Accordingly, the search in the data pool of the online service may be controlled by the search query that is combined with information provided by data clouds of the user that are maintained by the online service, such as implicitly maintained interest clouds or explicitly provided search clouds. A flowchart of a search procedure or method 200 involving implicitly and explicitly defined data clouds according to one embodiment is illustrated in FIG. 2. The example shown in FIG. 2 may be based on the example shown in FIG. 1. Therefore, same reference signs have been used for same or similar components.

The method 200 may start at step 102, wherein a search query may be received by an online service. Thereafter, a database 106 or a similar storage including data clouds may be accessed, and one or more data clouds related to the user may be retrieved in step 104. The data clouds may include an interest cloud 206a that may be automatically maintained by the online service, and/or at least one further data cloud that may be explicitly defined by the user in step 202, such as a search cloud 206b, which may also be stored in the database 106. For example, the user may define the search cloud 206b if the current interest cloud 206a is not specific enough for the desired content, or if an interest cloud does not exist. The user may also update the search cloud 206b. After the retrieval of the data clouds in step 104, the search is performed, wherein a data pool 208 is accessed and searched in step 108. The data pool 208 can be searched using well-known search techniques or search algorithms suitable for finding data with specified properties in the data pool. The search results may be implicitly refined based on the interest cloud 206a in step 210a. Furthermore, the search results may be explicitly refined based on the search cloud 206b in step 210b.

The respective steps 108, 210a, 210b of the search may be executed separately, sequentially, or in parallel. For example, on legacy systems, the search of the data pool according to step 108 may be performed independently of the subsequently performed implicit and explicit refinements 210a, 210b. Yet, it is to be understood that even though steps 108, 210a, 210b are shown as separate processing steps, the implicit and explicit refinements 210a, 201b may also be combined and even integrated in the search 108 of the data pool. Hence, the applied search technique or algorithm may directly take into account the items defined by the respective data clouds 206a, 206b. Also, one of the steps 210a, 210b may be omitted, for example, if the interest cloud 206a does not exist or is inappropriate, and/or if the user has not defined an explicit search cloud 206b.

The explicit control allows users to add a dimension of context and time to a search. The search procedure is also highly dynamic, since the explicit control may be achieved by updating implicitly generated data clouds or explicitly defining new data clouds. For example, a user may visit a city or an urban area such as New York, and may be looking for services near a current location. The user may never have been to New York before and may have no particular interest in the city; hence, there would be no reference to New York in any of the interest clouds maintained by the online service. Hence, searching would be a hit and miss affair if no explicit user control is provided.

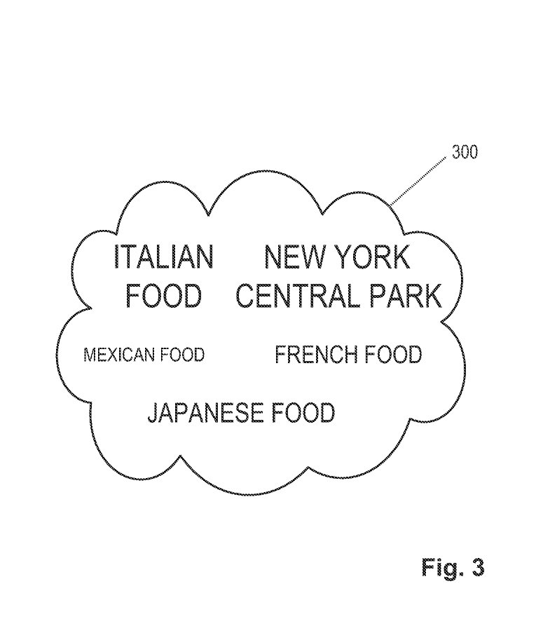

In order to deliver meaningful results when the user is, for example, in New York nearby to Central Park and would like to eat Italian food, the user may exercise explicit control over this particular situation by updating or defining personalized data clouds. They could have updated or, in this case, created an interest cloud for New York before they left home, however, in the situation above, it can be assumed that they will be near Central Park and looking for Italian food on a particular day, and at a particular time of the day. Accordingly, the user may also explicitly and quickly create a search tag cloud, which may also be enhanced by tracked features, such as a current location of the user. An example of a respective search cloud 300 is shown in FIG. 3. This may, in effect, change the system's search output instantly, thereby providing tailored search output according to the user's particular needs at a given instance, i.e., in context and time. Furthermore, if there is a change of mind, then the search cloud 300 could be updated, completely changed, upscaled, downscaled, or the like to correspond with whatever the user feels, needs, or wants at any point in context and time.

The user may enter tags or interests into the search cloud 300 that may be relevant in respect to context, time, mood, needs, etc. The tags may be sized or rated by the user according to their current needs or interests. The larger a tag, the greater a rating may be given to that tag or interest. Accordingly, the tag or interest will have a greater influence on the search results. Tags can be sized up and down at any time by the user, thus changing the relevance of any searches made. It is to be understood that, even though FIG. 3 represents the relevance of tags by size of the respective tag, for example, “Italian food” may have a higher relevance than “Mexican food,” rating of items may also be achieved in any other suitable way, such as by assigning a numerical value to each item, for example, a numerical value in the range between 0 and 1.

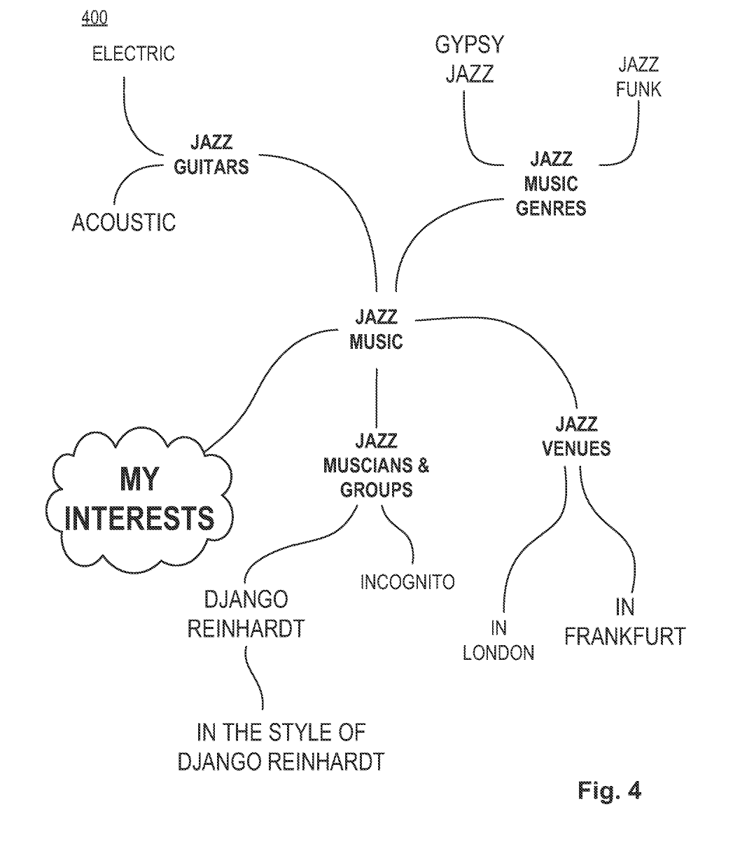

FIG. 4 shows details of an interest cloud 400 of a user of an online service that may be used for searching data according to one embodiment. The interest cloud 400 may, for example, be rendered on a display of a client device operated by the user. The interest cloud 400 may include items or tags, such as tags related to jazz music. Interests that are more relevant or more important to the user may be shown or rendered as tags with a larger font size. Respective tags may, therefore, be given a higher importance rating during search. The connections or links between respective tags may all have been explicitly defined by the user and given importance, or relevance ratings according to the user's particular interests, needs, mood, context, time, etc. The connections or links may also have been implicitly set by the online service based on an analysis of the tags and related interests of the user or other users. Hence, the font size may directly correspond to the importance of the interest to the user, and the importance may directly influence the refinement and/or weighting of the search results. For example, the user may search the online service for live jazz playing on a particular evening in Frankfurt. The online service may interrogate the user's interest cloud 400 and may see that certain topics are more important to the user than others. The online service may, therefore, weight the search results according to ratings the user has attached to particular aspects of jazz.

Even though tags and items related to jazz music are illustrated and discussed in the above example, it is to be understood that jazz music may be just one of the user's interests represented by the interest cloud 400. Accordingly, the interest cloud 400 may include various further interest tags that may be represented as headings and may be subdivided into specific topics. Accordingly, the tags of the interest cloud 400 shown in FIG. 4 may represent a subsection of the interest cloud 400, which may be larger and include more tags, as indicated by the element “my interests” of the interest cloud 400.

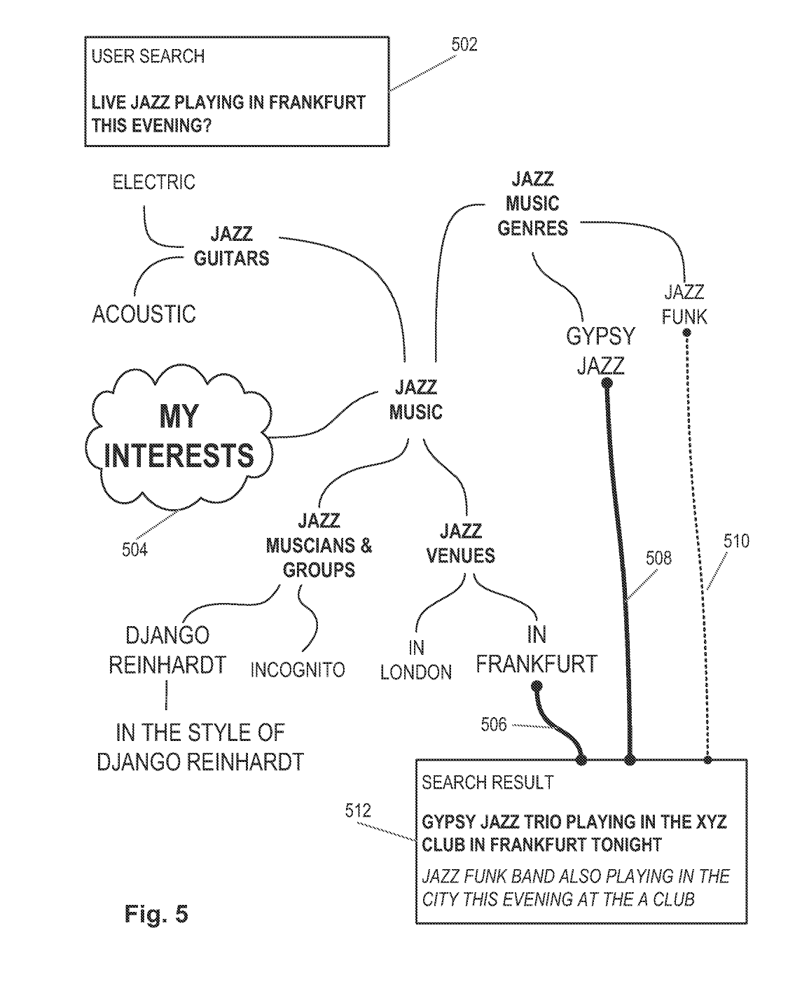

FIG. 5 shows a schematic representation of a search query initiated by a user, which is based on an interest cloud of the user. The user may formulate a search query 502 that may be used to search a data pool of an online service or a respective system. The online service may retrieve and access an interest cloud 504 of the user. Similar to the representation in FIG. 4, only a sub-section of the interest cloud 504 may be shown in FIG. 5, which may pertain to, for example, jazz music and related topics. The search query 502 may, for example, include an indication of a desired topic, such as live jazz, a location, such as Frankfurt, and a point in time, such as this evening. The online service may analyze the search query 502 and use the interest cloud 504 to search the data and further refine the search results. In this way, the system may tell the user that a “Gypsy Jazz” trio is playing in Frankfurt on the desired evening, even though the user has not explicitly searched for Gypsy Jazz. Rather, the system may determine that Gypsy Jazz is a favorite genre of the user directly from the interest cloud 504.

Furthermore, the system may derive from the importance ratings given to other genres of jazz, such as “Jazz Funk,” that the user may also be interested in another option for the night in question, which could be a Jazz Funk group also playing live in Frankfurt on the night in question. However, the search may be weighted based on the relevance of the particular items of the interest cloud 504, such as indicated by the bold lines 506, 508 and the dotted line 510. Accordingly, the search result 512 may be sorted according to the relevance, more relevant search responses may be highlighted, or the relevance may be shown in any other suitable way.

The search may also be explicitly refined by the user, such as by allocating or adjusting weights or ratings to the items, topics, and connections of the interest cloud 504 or defining new items, topics, and/or connections as well as respective weights or ratings in the interest cloud 504 or an additional search cloud (not shown). For example, a tracking sensor could be used to indicate that the user is located in a particular region, such as Frankfurt, which data may be considered during search, such as by including a topic “Frankfurt” into a search cloud. Hence, the user could only formulate a search query directed at live jazz and including a point in time, such as this evening, to generate results similar to the search result 512.

The user could also be provided with further information and data related to the search results. In the case of a GPS-equipped mobile device, a route to a location related to a search result could be automatically provided for the user. This could include a quickest and/or shortest route, parking information, public transport information, and other information, such as restaurants of interest to the user in or near the location.

The search results could also be used by an advertiser for providing information on products, services, deals, events, etc. related to the search results and interests of the user. This information could be implicitly pushed by the system to the user at exactly the right time and place, whenever a search query and items of a data cloud of the user match information associated with the targeted product and, for example, a tracked location of the user. For example, the system could offer a special deal to the user when the user is in or near to the place offering the deal. This may improve targeting of products and services, and may enable advertisers to better manage their business. For example, a quiet period in a restaurant could be countered with a special one-off deal, for example, a free dessert targeted to all diners who order a main meal in the next 15 minutes or a similar period.

Accordingly, the search approach greatly simplifies the search in large online data pools of online services and returns relevant information for users that better suits and satisfies their information needs, since the search results may be implicitly refined based on preferred interests of the user that are automatically determined by the online service, as well as by explicitly specifying recent interests related to context and time.

While some embodiments have been described in detail, it is to be understood that aspects of the disclosure can take many forms. In particular, the claimed subject matter may be practiced or implemented differently from the examples described, and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A computer-implemented method for searching data of an online service, the method comprising:
receiving a search query originating from a client device operated by a user;
accessing at least one data cloud provided by the online service, each data cloud including one or more items related to interests of the user;
performing a search on a data pool maintained by the online service using the search query, including searching the data pool subject to the search query and refining results of the search based on the items of the at least one data cloud; and
sending a search response based on the refined results of the search to the client device.

2. The method according to claim 1, further comprising:
receiving update information related to at least one item of the at least one data cloud;
updating the at least one data cloud based on the update information; and
dynamically refining the results of the search based on the updated at least one data cloud.

3. The method according to claim 1, further comprising:
receiving data on new items from the user;
creating a further data cloud including the new items; and
dynamically refining the results of the search based on the at least one data cloud and the further data cloud.

4. The method according to claim 1, further comprising weighting the results of the search according to a relevance of each result with respect to the items of the at least one data cloud.

5. The method according to claim 1, further comprising implicitly weighting the results of the search based on an interest cloud of the user maintained by the online service.

6. The method according to claim 1, further comprising:
tracking the user; and
dynamically creating items in the data cloud based on the tracking.

7. The method according to claim 1, further comprising deriving a geographical position of the user.

8. The method according to claim 1, further comprising refining the results of the search based on an indication of a time or time range included in the search query.

9. The method according to claim 1, further comprising:
accessing a data store including advertisement data;
selecting at least one advertisement based on the search query and the at least one data cloud; and
enhancing the search response with the at least one advertisement.

10. The method according to claim 9, further comprising pushing the at least one advertisement to the client device.

11. A computer-readable medium having instructions stored thereon, wherein said instructions in response to execution by a computing device cause said computing device to automatically perform a method for searching data of an online server, the method including:
receiving a search query originating from a client device operated by a user;
accessing at least one data cloud provided by the online service, each data cloud including one or more items related to interests of the user;
performing a search on a data pool maintained by the online service using the search query, including searching the data pool subject to the search query and refining results of the search based on the items of the at least one data cloud; and
sending a search response based on the refined results of the search to the client device.

12. An online system hosting an online service, the online system comprising:
an input interface configured to receive a search query originating from a client device operated by a user;
a data pool configured to store information related to the online service;
a storage configured to store at least one data cloud, each data cloud including one or more items related to interests of the user;
a processing component configured to access the storage and perform a search on the data pool using the search query by searching the data pool subject to the search query, and refining results of the search based on the items of the at least one data cloud; and
an output interface configured to send a search response based on the refined results of the search to the client device.

13. The system according to claim 12, wherein the input interface is further configured to receive update information related to at least one item of the at least one data cloud, and wherein the processing component is further configured to update the at least one data cloud based on the update information and dynamically refine the results of the search based on the updated at least one data cloud.

14. The system according to claim 12, wherein the input interface is further configured to receive data on new items from the user, and wherein the processing component is further configured to:
create a further data cloud including the new items; and
dynamically refine the results of the search based on the at least one data cloud and the further data cloud.

15. The system according to claim 12, wherein the at least one data cloud includes an interest cloud of the user maintained by the online service, and wherein the processing component is further configured to implicitly weight the results of the search based on the interest cloud.

16. The system according to claim 12, further comprising a tracking component configured to track the user and dynamically create items in the data cloud based on the tracked information associated with the user.

17. The system according to claim 12, wherein at least one item of the data cloud is indicative of a geographical position of the user, and wherein the processing component is further configured to derive the geographical position of the user utilizing a tracking sensor.

18. The system according to claim 12, wherein the search query includes an indication of a time or time range, and wherein the processing component is further configured to refine the results of the search based on the indication of the time or time range.

19. The system according to claim 12, further comprising a data store including advertisement data, wherein the processing component is further configured to:
access the data store;
select at least one advertisement based on the search query and the at least one data cloud; and
enhance the search response with the at least one advertisement.

20. The system according to claim 12, wherein the search response includes one or more of a text, a video clip, an image, an email, a message, and audio content.
